(19) United States
(12) Patent Application Publication
(10) Pub. No.: US 2025/0304148 A1
(43) Pub. Date: Oct. 2, 2025

(54) STEERING CONTROL DEVICE, STEERING ASSIST DEVICE, AND STEERING SYSTEM

(71) Applicant: HL MANDO CORPORATION, Pyeongtaek-si (KR)

(72) Inventor: Tony JUNG, Pyeongtaek-si (KR)

(21) Appl. No.: 18/890,523

(22) Filed: Sep. 19, 2024

(30) Foreign Application Priority Data
Mar. 26, 2024 (KR) 10-2024-0040906

(51) Int. Cl. B62D 5/04; B62D 6/00

(52) U.S. Cl. CPC B62D 5/0463; B62D 5/0493; B62D 6/008

(57) ABSTRACT

The present embodiments relate to a steering control device, a steering assist device, and a steering system. A steering control device may include an input-side steering control module controlling an input-side steering motor to assist an input-side mechanism mechanically separated from an output-side mechanism connected with a wheel and connected with a steering wheel. The input-side steering control module may include a repulsive force controller controlling a repulsive force of the input-side steering motor based on a steering assist current related to the input-side steering motor and an operation state of the input-side steering control module.

### CROSS-REFERENCE TO RELATED APPLICATION

This application claims priority from Korean Patent Application No. 10-2024-0040906, filed on Mar. 26, 2024, which is hereby incorporated by reference for all purposes as if fully set forth herein.

### BACKGROUND

### Technical Field

The present embodiments relate to a steering control device, a steering assist device, and a steering system.

### Description of Related Art

In general, steering system refers to a system in which the driver of a vehicle may change the steering angle of the wheels of a vehicle based on the steering force (or rotational force) applied to the steering wheel. Electromotive power steering systems, e.g., electric power steer (EPS), have been recently applied to vehicles to ensure stable steering by reducing the steering force of the steering wheel.

There is recently ongoing research and development on steer-by-wire-based steering systems, in particular, to provide drivers with a stable sense of steering of the steering wheel.

### BRIEF SUMMARY

The present embodiments may provide a steering control device, a steering assist device, and a steering system that may stably provide a sense of steering of the steering wheel to the driver.

In an aspect, the present embodiments may provide a steering control device, comprising an input-side steering control module controlling an input-side steering motor to assist an input-side mechanism mechanically separated from an output-side mechanism connected with a wheel and connected with a steering wheel, wherein the input-side steering control module includes a repulsive force controller controlling a repulsive force of the input-side steering motor based on a steering assist current related to the input-side steering motor and an operation state of the input-side steering control module.

In another aspect, the present embodiments may provide a steering assist device comprising an input-side steering actuator assisting an input-side mechanism mechanically separated from an output-side mechanism connected with a wheel and connected with a steering wheel, and an input-side steering assist device including an input-side steering control module controlling an input-side steering motor included in the input-side steering actuator, wherein the input-side steering control module includes a repulsive force controller controlling a repulsive force of the input-side steering motor based on a steering assist current related to the input-side steering motor and an operation state of the input-side steering control module.

In another aspect, the present embodiments may provide a steering system, comprising an input-side mechanism mechanically separated from an output-side mechanism connected with a wheel and connected with a steering wheel and an input-side steering assist device including an input-side steering actuator assisting the input-side mechanism and an input-side steering control module controlling an input-side steering motor included in the input-side steering actuator, wherein the input-side steering control module includes a repulsive force controller controlling a repulsive force of the input-side steering motor based on a steering assist current related to the input-side steering motor and an operation state of the input-side steering control module.

According to the present embodiments, there may be provided a steering control device, a steering assist device, and a steering system that may stably provide a sense of steering of the steering wheel to the driver.

### DESCRIPTION OF THE SEVERAL VIEWS OF THE DRAWINGS

The above and other objects, features, and advantages of the disclosure will be more clearly understood from the following detailed description, taken in conjunction with the accompanying drawings, in which:

FIG. 1 is a block diagram illustrating a configuration of a steering system according to the present embodiments;

FIG. 2 is a view illustrating a steering device according to the present embodiments;

FIG. 3 is a block diagram illustrating a configuration of a steering assist device according to an embodiment;

FIG. 4 is a block diagram illustrating a configuration of an input-side steering assist device according to the present embodiments;

FIG. 5 is a block diagram illustrating a configuration of an output-side steering assist device according to the present embodiments;

FIG. 6 is a block diagram illustrating configurations of an input-side steering control module and an output-side steering control module according to the present embodiments;

FIG. 7 is a block diagram illustrating a configuration of a steering control device according to the present embodiments;

FIG. 8 is a block diagram illustrating a configuration of a repulsive force controller according to the present embodiments;

FIGS. 9 and 10 are views specifically illustrating repulsive force control according to the present embodiments; and

FIG. 11 is a view illustrating a computer system for a steering control device, a steering assist device, and a steering system according to the present embodiments.

### DETAILED DESCRIPTION

In the following description of examples or embodiments of the disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the disclosure, detailed descriptions of well-known functions and components incorporated herein will be omitted when it is determined that the description may make the subject matter in some embodiments of the disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements, etc., but is used merely to distinguish the corresponding element from other elements.

When it is mentioned that a first element “is connected or coupled to”, “contacts or overlaps”, etc., a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc., each other via a fourth element. Here, the second element may be included in at least one of two or more elements that “are connected or coupled to”, “contact or overlap”, etc., each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes, etc., are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

The text “at least one of A and B” as used herein should be understood to include at least one of A, or at least one of B, or at least one of both A and B. This similarly applies to “at least one of A, B, and C” and so forth.

One of ordinary skill in the art would readily understand that the term “location” used herein may be interchangeably used with “position,” “displacement,” “movement,” or “angle” or other terms having an equivalent meaning thereto.

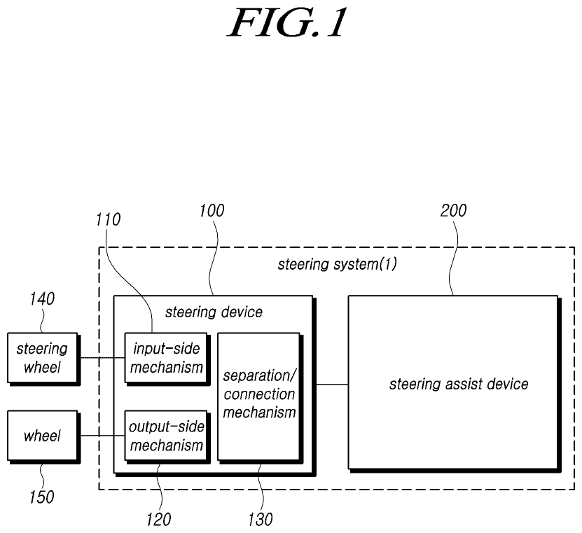

FIG. 1 is a block diagram illustrating a configuration of a steering system according to the present embodiments.

Referring to FIG. 1, according to the present embodiments, a steering system 1 may include at least one of a steering device 100 or a steering assist device 200.

The steering device 100 may change the steering angle of a wheel 150 based on a steering force (or rotational force) applied to the steering wheel 140. The steering device 100 may include at least one of an input-side mechanism 110, an output-side mechanism 120, or a separation/connection mechanism 130.

There may be provided one or more input-side mechanisms 110. The input-side mechanism 110 may be connected to the steering wheel 140. The input-side mechanism 110 may rotate in a rotational direction of the steering wheel 140 or in a direction opposite to the rotational direction of the steering wheel 140. The input-side mechanism 110 may include a steering shaft connected to the steering wheel 140 but, without limitations thereto, may include any mechanism (or device) that may rotate in the rotational direction of the steering wheel 140 or in the direction opposite to the rotational direction of the steering wheel 140.

There may be provided one or more output-side mechanisms 120. The output-side device 120 may be connected to the input-side device 110 by at least one of an electrical or mechanical connection. The output-side mechanism 120 may be connected to the wheel 150, changing the steering angle (or movement) of the wheel 150. The output-side mechanism 120 may include at least one of a pinion, a rack, a tie rod, or a knuckle arm but, without limitations thereto, may include any mechanism (or device) that may change the steering angle (or movement) of the wheel 150.

There may be provided one or more separation/connection mechanisms 130. The separation/connection mechanism 130 may be connected to the input-side mechanism 110 and the output-side mechanism 120. The separation/connection mechanism 130 may mechanically and/or electrically connect or separate the input-side mechanism 110 and the output-side mechanism 120. The separation/connection mechanism 130 may include a clutch but, without limitations thereto, may include any mechanism (or device) that may connect and/or separate the input-side mechanism 110 and the output-side mechanism 120.

According to the present embodiments, the steering device 100 may include at least one of a steering device in which an input-side mechanism and an output-side mechanism are connected mechanically, a steering device (or steer-by-wire (SbW)) in which an input-side mechanism and an output-side mechanism are connected electrically, or a steering device (or an SbW including a clutch) in which an input-side mechanism and an output-side mechanism are connected with a separation/connection mechanism.

There may be provided one or more steering wheels 140 or one or more wheels 150. The steering wheel 140 and the wheel 150 may be separately provided as illustrated in the drawings but, without limitations thereto, may be included in the steering device 100.

The steering assist device 200 may be connected with the steering device 100. The steering assist device 200 may assist the steering device 100.

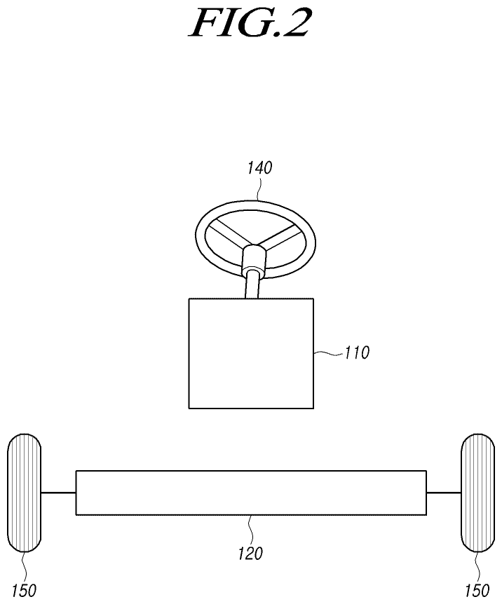

FIG. 2 is a view illustrating a steering device according to the present embodiments.

Referring to FIG. 2, according to an embodiment, a steering device 100 may include an input-side mechanism 110 connected with a steering wheel 140 and an output-side mechanism 120 mechanically separated from the input-side mechanism 110 and connected with a wheel 150. In other words, according to an embodiment, the steering device 100 may be a steer-by-wire (SbW) steering device.

The input-side mechanism 110 may rotate in a rotational direction of the steering wheel 140 or in a direction opposite to the rotational direction of the steering wheel 140, and may include, e.g., a steering shaft connected with the steering wheel 140. The output-side mechanism 120, which is mechanically separated from the input-side mechanism 110 and is electronically connected therewith, may be connected with the wheel 150, changing the steering angle (or movement) of the wheel 150. The input-side mechanism 110 may include at least one of a pinion, a rack, a tie rod, or a knuckle arm.

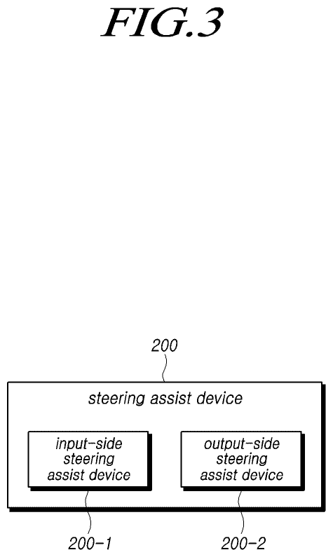

FIG. 3 is a block diagram illustrating a configuration of a steering assist device according to an embodiment.

Referring to FIG. 3, a steering assist device 200 according to the present embodiments may include at least one assist device of an input-side steering assist device 200-1 and an output-side steering assist device 200-2. The input-side steering assist device 200-1 and the output-side steering assist device 200-2 may be connected by at least one of an electrical, magnetic, or mechanical connection.

The input-side steering assist device 200-1 may be connected to the input-side mechanism 110 by at least one of an electrical, magnetic, or mechanical connection. The input-side steering assist device 200-1 may assist the input-side mechanism 110.

The output-side steering assist device 200-2 may be connected with the output-side mechanism 120 by at least one of electrical, magnetic or mechanical connection. The output-side steering assist device 200-2 may assist the input-side mechanism 110.

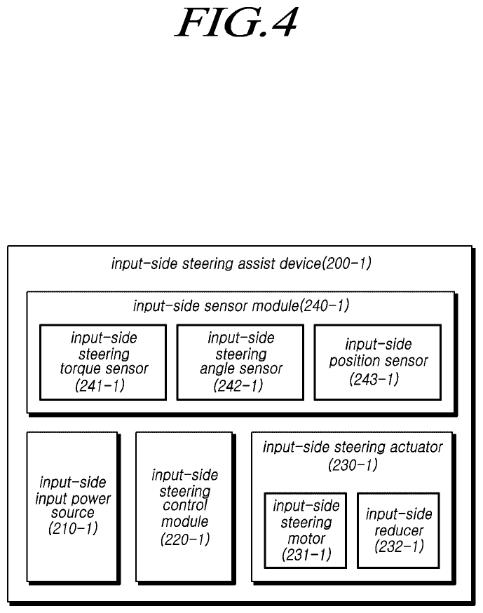

FIG. 4 is a block diagram illustrating a configuration of an input-side steering assist device according to the present embodiments.

Referring to FIG. 4, an input-side steering assist device 200-1 according to the present embodiments may include at least one of an input-side input power source 210-1, an input-side steering control module 220-1, an input-side steering actuator 230-1, and an input-side sensor module 240-1.

There may be provided one or more input-side input power sources 210-1. The input-side input power source 210-1 may include at least one of a direct current (DC) power source or an alternating current (AC) power source. In particular, the DC power source may include a battery but, without limitations thereto, may include any power source may provide DC power.

The input-side sensor module 240-1 may include at least one sensor. Here, the sensor may include at least one of an input-side steering torque sensor 241-1, an input-side steering angle sensor 242-1, or an input-side position sensor 243-1 but, without limitations thereto, may include any sensor capable of measuring the state of the vehicle and the steering state of the vehicle.

There may be provided one or more input-side steering torque sensors 241-1. The input-side steering torque sensor 241-1 may measure the steering torque of the steering wheel 140 and provide the torque information about the steering wheel 140 to the input-side steering control module 220-1. There may be provided one or more input-side steering angle sensors 242-1. The input-side steering angle sensor 242-1 may measure the steering angle of the steering wheel 140 and provide steering angle information about the steering wheel 140 to the input-side steering control module 220-1. There may be provided one or more input-side position sensors 243-1. The input-side position sensor 243-1 may measure at least one of the position of the input-side mechanism 110 and the position of the input-side steering motor 231-1 and provide at least one of position information about the input-side mechanism 110 and position information about the input-side steering motor 231-1 to the input-side steering control module 220-1. Here, the input-side position sensor 243-1 may include a displacement sensor capable of measuring the position of the input-side mechanism 110 and may include a motor position sensor 33 capable of measuring the position of the input-side steering motor 231-1.

There may be provided one or more input-side steering control modules 220-1. The input-side steering control module 220-1 may be connected to the input-side input power source 210-1. The input-side steering control module 220-1 may receive electrical energy from the input-side input power source 210-1 and filter noise of the electrical energy.

The input-side steering control module 220-1 may generate a steering motor control signal based on information (e.g., at least one of the steering torque information, steering angle information, position information, or vehicle speed information) received from each component in the steering system 1 and/or the vehicle.

The input-side steering control module 220-1 may convert the filtered electric energy according to the steering motor control signal to thereby generate an assist current and control the input-side steering actuator 230-1 (or input-side steering motor 231-1) based on the assist current.

In the present embodiments, the assist current may be referred to as an assist steering force.

There may be provided one or more input-side steering actuators 230-1. The input-side steering actuator 230-1 may be connected with the input-side steering control module 220-1. The input-side steering actuator 230-1 may operate based on the assist current provided from the input-side steering control module 220-1, assisting (e.g., reaction force) the steering device 100 in steering.

The input-side steering actuator 230-1 may include at least one of an input-side steering motor 231-1 and an input-side reducer 232-1. There may be provided one or more input-side steering motors 231-1 or one or more input-side reducers 232-1. At least one of the input-side steering motor 231-1 or the input-side reducer 232-1 may be connected with the input-side steering control module 220-1.

If the input-side steering actuator 230-1 includes the input-side steering motor 231-1, the input-side steering motor 231-1 may operate based on the assist current provided from the input-side steering control module 220-1, assisting the steering device 100 in steering.

If the input-side steering actuator 230-1 includes the input-side steering motor 231-1 and the input-side reducer 232-1, the input-side steering motor 231-1 may operate based on the assist current provided from the input-side steering control module 220-1, and the input-side reducer 232-1 may operate according to the operation of the input-side steering motor 231-1 to thereby assisting the steering device 100 in steering.

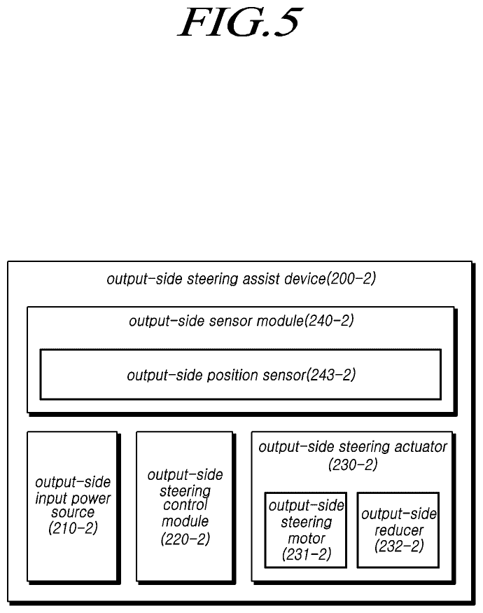

FIG. 5 is a block diagram illustrating a configuration of an output-side steering assist device according to the present embodiments.

Referring to FIG. 5, an output-side steering assist device 200-2 according to the present embodiments may include at least one of an output-side input power source 210-2, an output-side input power source 210-2, an output-side steering control module 220-2, an output-side steering actuator 230-2, and an output-side sensor module 240-2.

There may be provided one or more output-side input power sources 210-2. The input power source 210 may include at least one of a direct current (DC) power source or an alternating current (AC) power source. In particular, the DC power source may include a battery but, without limitations thereto, may include any power source may provide DC power.

The output-side sensor module 240-2 may include at least one sensor. Here, the sensor may include an output-side position sensor 243-2 but, without limitations thereto, may include any sensor capable of measuring the state of the vehicle and the steering state of the vehicle.

There may be provided one or more output-side position sensors 243-2. The output-side position sensor 243-2 may measure at least one of the position of the output-side mechanism 120 and the position of the output-side steering motor 231-2 and provide at least one of position information about the output-side mechanism 120 and position information about the output-side steering motor 231-2 to the output-side steering control module 220-2. Here, the output-side position sensor 243-2 may include a displacement sensor (e.g., a rack displacement (position) sensor) capable of measuring the position of the output-side mechanism 120.

There may be provided one or more output-side steering control modules 220-2. The output-side steering control module 220-2 may be connected to the output-side input power source 210-2. The output-side steering control module 220-2 may receive electrical energy from the output-side input power source 210-2 and filter noise of the electrical energy.

The output-side steering control module 220-1 may generate a steering motor control signal based on information (e.g., at least one of the steering torque information, steering angle information, position information, or vehicle speed information) received from each component in the steering system 1 and/or the vehicle.

The output-side steering control module 220-2 may convert the filtered electric energy according to the steering motor control signal to thereby generate an assist current and control the output-side steering actuator 230-2 (or output-side steering motor 231-2) based on the assist current.

There may be provided one or more output-side steering actuators 230-2. The output-side steering actuator 230-2 may be connected with the output-side steering control module 220-2. The output-side steering actuator 230-2 may operate based on the assist current provided from the output-side steering control module 220-2, assisting (e.g., reaction force) the steering device 100 in steering.

The output-side steering actuator 230-2 may include at least one of an output-side steering motor 231-2 and an output-side reducer 232-2. There may be provided one or more output-side steering motors 231-2 or one or more output-side reducers 232-2. At least one of the output-side steering motor 231-2 or the output-side reducer 232-2 may be connected with the output-side steering control module 220-2.

If the output-side steering actuator 230-2 includes the output-side steering motor 231-2, the output-side steering motor 231-2 may operate based on the assist current provided from the output-side steering control module 220-2, assisting the steering device 100 in steering.

If the output-side steering actuator 230-2 includes the output-side steering motor 231-2 and the output-side reducer 232-2, the output-side steering motor 231-2 may operate based on the assist current provided from the output-side steering control module 220-2, and the output-side reducer 232-2 may operate according to the operation of the output-side steering motor 231-2 to thereby assisting the steering device 100 in steering.

Referring to FIGS. 4 and 5, the input-side input power source 210-1 and the output-side input power source 210-2 may be different power sources as shown in the drawings but, without limitations thereto, may be the same power source.

Further, the input-side steering motor 231-1 and/or the output-side steering motor 231-2 may include at least one of a single winding-type steering motor or a dual winding-type steering motor but, without limitations thereto, may include any motor that may assist the steering device in steering.

The input-side steering motor 231-1 and/or the output-side steering motor 231-2 may include at least one of a single-phase type motor, a three-phase type motor, or a five-phase type motor but, without limitations thereto, may include any motor that may assist the steering device in steering.

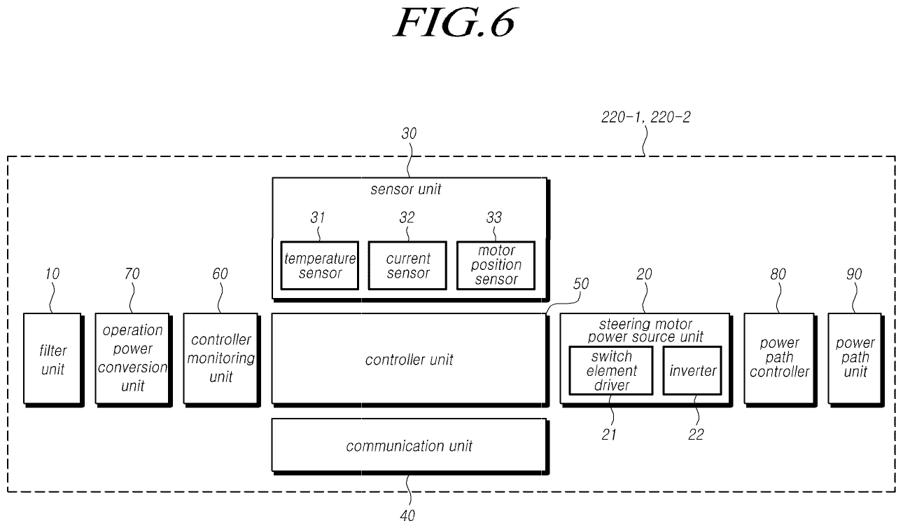

FIG. 6 is a block diagram illustrating configurations of an input-side steering control module and an output-side steering control module according to the present embodiments.

Referring to FIG. 6, each of an input-side steering control module 220-1 and an output-side steering control module 220-2 may include at least one of a filter unit 10, a steering motor power source unit 20, a sensor unit 30, a communication unit 40, a controller unit 50, a controller monitoring unit 60, an operation power conversion unit 70, or a power path controller 80.

The term “unit” or “module” as used herein may include any electrical circuitry, features, components, an assembly of electronic components, or the like. That is, “unit” or “module” may include any processor-based system including systems using microcontrollers, integrated circuits, chips, microchips, reduced instruction set computers (RISC), application specific integrated circuits (ASICs), field-programmable gate arrays (FPGAs), graphical processing units (GPUs), logic circuits, and any other circuit or processor capable of executing the various operations and functions described herein. The above examples are examples only, and are thus not intended to limit in any way the definition or meaning of the term “unit” or “module.”

In some embodiments, the various units or modules described herein may be included in or otherwise implemented by processing circuitry such as a microprocessor, microcontroller, or the like.

As described above, each of the input-side steering control module 220-1 and the output-side steering control module 220-2 may include the same components but, without limitations thereto, may include different components by deleting, adding or modifying components.

The following description focuses primarily on the input-side steering control module 220-1 but this is merely for simplicity of description, the description made based on the input-side steering control module 220-1 may be applied to the output-side steering control module 220-2. For example, the description made based on the input-side steering control module 220-1 may be applied to the output-side steering control module 220-2 by replacing the term “input-side” used in describing the input-side steering control module 220-1 with the term “output-side.”

There may be provided one or more filter units 10. The filter unit 10 may be connected to an input-side input power source 231-1. The filter unit 10 may filter noise included in electric energy provided from the input-side input power source 231-1 and provide the filtered electric energy to the steering motor power source unit 20 and the operation power conversion unit 70.

There may be provided one or more steering motor power source units 20. The steering motor power source unit 20 may be connected with the filter unit 10 and may receive filtered electric energy. The steering motor power source unit 20 may be connected with the controller unit 50 and may receive a steering motor control signal. The steering motor power source unit 20 may generate an assist current by converting the filtered electric energy based on the steering motor control signal, and control the steering motor based on the assist current.

The steering motor power source unit 20 may include at least one of a switch element driver 21 or an inverter 22. There may be provided one or more switch element drivers 21 or one or more inverters 22.

The switch element driver 21 may receive the steering motor control signal from the controller unit 50, generate a switch element control signal based on the steering motor control signal, and provide the switch element control signal to the inverter 22. The inverter 22 may convert the filtered electric energy of the filter unit 10 according to the switch element control signal, generating an assist current.

The inverter 22 may include a switch and/or a transistor but, without limitations thereto, may include any element (or device) that may generate an assist current by converting the electric energy according to the switch element control signal.

If the inverter 22 includes a field effect transistor (FET), the switch element driver 21 may be a gate driver. Accordingly, the gate driver may receive the steering motor control signal from the controller unit 50, generate a gate control signal based on the steering motor control signal, and provide the gate control signal to the inverter 22. The inverter 22 may convert the filtered electric energy of the filter unit 10 according to the gate control signal, generating an assist current.

There may be provided one or more power path controllers 80. The power path controller 80 may be located between the steering motor power source unit 20 (or the inverter 22) and the input-side steering actuator 230-1 (or the input-side steering motor 231-1), supplying or cutting off the supply of the assist current received from the steering motor power source unit 20 (or the inverter 22) to the input-side steering actuator 230-1 (or the input-side steering motor 231-1).

The power path controller 80 may include at least one phase disconnector (PCO). The phase disconnector is an element or circuit capable of cutting off a phase, and may include at least one of a switch, a circuit breaker, a disconnecting switch, or a transistor but, without limitations thereto, may include any element and/or circuit that may cut off a phase.

There may be provided one or more power path units 90. The power path unit 90 may be located between the steering motor power source unit 20 (or the inverter 22) and the input-side steering actuator 230-1 (or the input-side steering motor 231-1), connecting them and thereby providing a power path through which the assist current may flow from the steering motor power source unit 20 (or the inverter 22) to the input-side steering actuator 230-1 (or the input-side steering motor 231-1).

Meanwhile, the power path controller 80 may be positioned on the power path unit 90. Thus, the power path controller 80 may control the power path of the power path unit 90, supplying or cutting off the supply of the assist steering force received from the steering motor power source unit 20 (or inverter 22) to the input-side steering actuator 230-1 (or input-side steering motor 231-1).

The sensor unit 30 may include at least one of a temperature sensor 31, a current sensor 32, or a motor position sensor 33 but, without limitations thereto, may include any sensor that may measure the state of the steering system 1 (or the steering control module). There may be provided one or more temperature sensors 31, one or more current sensors 32, or one or more motor position sensors 33.

The temperature sensor 31 may measure the temperature of the input-side steering control module 220 and provide the temperature information to the controller unit 50. The current sensor 32 may measure the assist current (or assist steering force) provided from the steering motor power source unit 20 to the input-side steering actuator 230-1 (or the input-side steering motor 231-1) and provide assist current information to the controller unit 50. The motor position sensor 33 may measure the position of the input-side steering motor 231-1 and provide the position information about the input-side steering motor 231-1 to the controller unit 50. As described above, the motor position sensor 33 may be included in the input-side steering control module 220-1 but, without being limited thereto, the motor position sensor 33 may be separately provided.

There may be provided one or more communication units 40. The communication unit 40 may include at least one of an internal communication unit or an external communication unit. When there are provided a plurality of steering control modules (e.g., an input-side steering control module and/or an output-side steering control module), the internal communication unit may connect to other steering control modules to receive or provide information therebetween. The external communication unit may be connected with the vehicle to receive vehicle state information (e.g., vehicle speed information) from the vehicle or provide information related to the steering system to the vehicle.

There may be provided one or more controller units 50. The controller unit 50 may be connected with each component of the input-side steering control module 220-1 to provide or receive information and, based thereupon, control the operation for each component of the input-side steering control module 220-1.

For example, the controller unit 50 may generate a steering motor control signal based on at least one of the torque information about the steering wheel 140, steering angle information about the steering wheel 140, temperature information, assist current information, position information (position information about the input-side mechanism 110, position information about the output-side mechanism 120, and position information about the input-side and/or output-side steering motor 231-2), vehicle state information (e.g., vehicle speed information), state information about the input-side input power source 231-1, short circuit (or overcurrent) state information, current sensing information about the filter unit 10, or state information about the input-side and/or output-side steering motor 231-2, and provide the steering motor control signal to the steering motor power source unit 20 (or switch element driver 21), or may generate a separation/connection control signal (e.g., a clutch control signal) and provide the separation/connection control signal to the separation/connection mechanism 130.

The controller unit 50 may include a microcontroller but, without limitations thereto, may include any device (or computer) that may process (or execute or compute) programs.

The controller unit 50 may include at least one or more of one or more processors, a memory, a storage unit, a user interface input unit, or a user interface output unit which may communicate with one another via a bus. The controller unit 50 may also include a network interface for accessing a network. The processor may be a central processing unit (CPU) or semiconductor device that executes processing instructions stored in the memory and/or the storage unit. The memory and the storage unit may include various types of volatile/non-volatile storage media. For example, the memory may include a read only memory (ROM) and a random access memory (RAM). Here, the producer 120 may include at least one core. In particular, if the at least one core includes a plurality of cores, at least one of the plurality of cores may include a lockstep core.

The controller monitoring unit 60 may be connected with the controller unit 50. The controller monitoring unit 60 may monitor the operation state of the controller unit 50. For example, the controller unit 50 may provide a watchdog signal to the controller monitoring unit 60. The controller monitoring unit 60 may be cleared based on the watchdog signal received from the controller unit 50 or may generate a reset signal and provide the reset signal to the controller unit 50.

The controller monitoring unit 60 may include a watchdog but, without limitations thereto, may include any device capable of monitoring the controller unit. In particular, a watchdog may include a window watchdog having a deadline, that is, a start and an end.

The operation power conversion unit 70 may be connected with the filter unit 10. The operation power conversion unit 70 may generate an operating voltage for each component of the input-side steering control module 220-1 by converting the filtered electric energy of the filter unit 10. The operation power conversion unit 70 may include at least one of a DC-DC converter or a regulator but, without limitations thereto, may include any device that may convert the filtered electrical energy to thereby generate an operating voltage for each component of the input-side steering control module 220-1 and/or for the outside of the steering control module.

The input-side steering control module 220-1 may include an electronic control unit (ECU) but, without limitations thereto, may include any controller (or system) that may perform electronic control.

Meanwhile, the assist steering force described in the present embodiments may have the same meaning as the steering assist current (or torque).

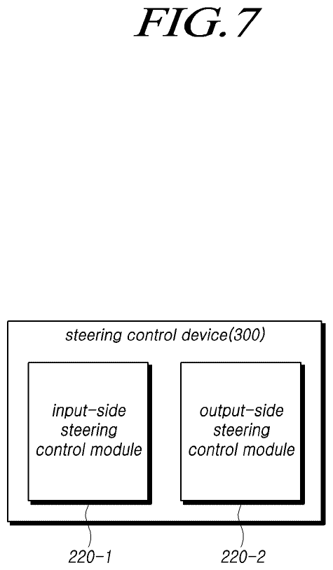

FIG. 7 is a block diagram illustrating a configuration of a steering control device according to the present embodiments.

Referring to FIG. 7, a steering assist device 300 according to the present embodiments may include at least one of an input-side steering control module 220-1 and an output-side steering control module 220-2. The input-side steering control module 220-1 and the output-side steering control module 220-2 may be connected to each other.

Meanwhile, the steering control device 300 may be referred to as a steering control module. Further, the input-side steering control module 220-1 may be referred to as a steering control device or an input-side steering control device. Further, the output-side steering control module 220-2 may be referred to as a steering control device or an output-side steering control device.

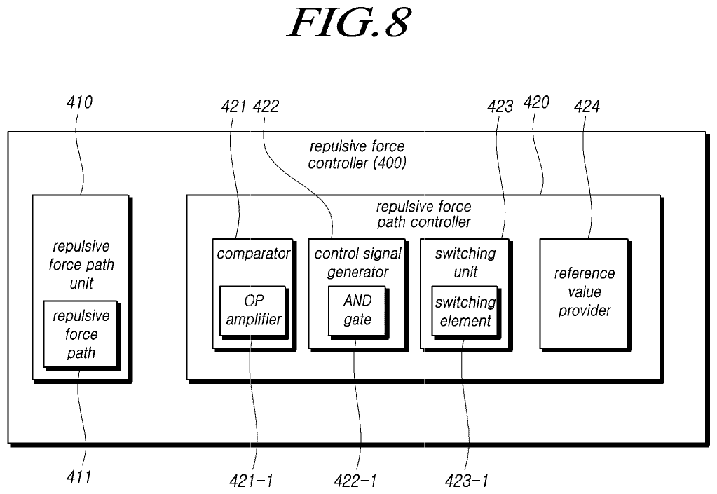

FIG. 8 is a block diagram illustrating a configuration of a repulsive force controller according to the present embodiments.

Referring to FIG. 8, in FIG. 8, a repulsive force controller 400 according to the present embodiments may include at least one of a repulsive force path unit 410 and a repulsive force path controller 420. The repulsive force path unit 410 and the repulsive force path controller 420 may be connected to each other. There may be provided one or more repulsive force path units 410 and one or more repulsive force path controllers 420.

The repulsive force path unit 410 may include a repulsive force path 411. There may be provided one or more repulsive force paths 411.

The repulsive force path controller 420 may include at least one of a comparator 421 (also referred to as a comparator circuit 421), a control signal generator 422 (also referred to as a control signal generator circuit 422), a switching unit 423, and a reference value provider 424. The comparator 421, the control signal generator 422, the switching unit 423, and the reference value provider 424 may be connected to each other. There may be provided one or more comparators 421, one or more control signal generators 422, one or more switching units 423, and one or more reference value providers 424.

The comparator 421 may include an OP amplifier 421-1 but, without limitations thereto, may include any element and/or algorithm capable of comparing signals. There may be provided one or more OP amplifiers 421-1.

The control signal generator 422 may include an AND gate 422-1 but, without limitations thereto, may include any element and/or algorithm capable of generating a control signal. There may be provided one or more AND gates 422-1.

The switching unit 423 may include a switching element 423-1 but, without limitations thereto, may include any element and/or algorithm capable of switching a path. There may be provided one or more switching elements 423-1.

The OP amplifier 421-1, the AND gate 422-1, and the switching element 423-1 may be connected to each other.

Meanwhile, the repulsive force controller 400 according to the present embodiments may be referred to as a repulsive force control device.

Referring to FIGS. 1 to 8, a steering control device 300 according to the present embodiments may include an input-side steering control module 220-1 controlling an input-side steering motor 231-1 to assist an input-side mechanism 110 mechanically separated from an output-side mechanism 120 connected with a wheel 150 and connected with a steering wheel 140. The input-side steering control module 220-1 may include a repulsive force controller 400 controlling a repulsive force of the input-side steering motor 231-1 based on a steering assist current related to the input-side steering motor 231-1 and an operation state of the input-side steering control module 220-1.

Specifically, the input-side steering control module 220-1 may control the input-side steering motor 231-1. The input-side steering motor 231-1 controlled by the input-side steering control module 220-1 may assist the input-side mechanism 110. Here, the input-side mechanism 110 may be connected to the steering wheel 140. In particular, the input-side mechanism 110 may be mechanically separated from the output-side mechanism 120 connected with the wheel 150.

In other words, the input-side steering control module 220-1 may control the input-side steering motor 231-1 to assist the input-side mechanism 110 mechanically separated from the output-side mechanism 120 connected with the wheel 150 and connected with the steering wheel 140.

Meanwhile, the output-side steering control module 220-2 may control the output-side steering motor 231-2. The output-side steering motor 231-2 controlled by the output-side steering control module 220-2 may assist the output-side mechanism 120. Here, the output-side mechanism 120 may be connected with the wheel 150. The output-side mechanism 120 may be mechanically separated from the input-side mechanism 110 connected with the steering wheel 140.

In other words, the output-side steering control module 220-2 may control the output-side steering motor 231-2 to assist the output-side mechanism 120 mechanically separated from the input-side mechanism 110 connected with the steering wheel 140 and connected with the wheel 150.

The input-side steering control module 220-1 may include a repulsive force controller 400. The repulsive force controller 400 may control the repulsive force of the input-side steering motor 231-1. For example, the repulsive force controller 400 may control the repulsive force of the input-side steering motor 231-1 based on the steering assist current and the operation state of the input-side steering control module 220-1.

In other words, the input-side steering control module 220-1 may include the repulsive force controller 400 for controlling the repulsive force of the input-side steering motor 231-1 based on the steering assist current and the operation state of the input-side steering control module 220-1.

Here, the steering assist current may mean a current related to the input-side steering motor 231-1.

In other words, the input-side steering control module 220-1 may include the repulsive force controller 400 controlling the repulsive force of the input-side steering motor 231-1 based on the steering assist current related to the input-side steering motor 231-1 and the operation state of the input-side steering control module 220-1.

Here, the steering assist current related to the input-side steering motor 231-1 may include a current related to the operation of the input-side steering motor 231-1. For example, the current related to the operation of the input-side steering motor 231-1 may include at least one of a current for controlling the input-side steering motor 231-1 (or a current flowing (or provided) to the input-side steering motor 231-1) and a current generated by controlling the input-side steering motor 231-1 (or a current flowing (or provided) from the input-side steering motor 231-1) but, without limitations thereto, may include any current related to the operation of the input-side steering motor 231-1.

The repulsive force controller 400 may include a repulsive force path unit 410 and a repulsive force path controller 420.

The repulsive force path unit 410 may be connected to the power path unit 90.

Here, a steering assist current may flow through the power path unit 90. Accordingly, the repulsive force path unit 410 may be connected to the power path unit 90 through which the steering assist current flows.

Here, the power path unit 90 may be connected with the input-side steering motor 231-1. Accordingly, the repulsive force path unit 410 may be connected with the power path unit 90 connected with the input-side steering motor 231-1 and through which the steering assist current flows.

The repulsive force path controller 420 may control the repulsive force path unit 410 to control the repulsive force of the input-side steering motor 231-1.

For example, the repulsive force path controller 420 may control the repulsive force path unit 410 based on the steering assist current and the operation state of the input-side steering control module 220-1 to control the repulsive force of the input-side steering motor 231-1.

In other words, the repulsive force path controller 420 may control the repulsive force path unit 410 based on the steering assist current and the operation state of the input-side steering control module 220-1 so that the repulsive force of the input-side steering motor 231-1 is controlled.

The repulsive force path controller 420 may include a comparator 421, a control signal generator 422, and a switching unit 423.

The comparator 421 may compare a steering assist current sensing value with a reference value.

Here, the steering assist current sensing value may be a value obtained by sensing the steering assist current. In other words, the comparator 421 may generate a comparison result by comparing the steering assist current sensing value obtained by sensing the steering assist current with the reference value.

Here, the reference value may be a measure for determining the state of the steering assist current. The reference value may be preset but, without limitations thereto, may be provided in real time. There may be provided one or more reference values.

Specifically, the comparator 421 may generate a difference value by comparing the steering assist current sensing value with the reference value, and may compare the difference value with a reference range.

Here, the difference value may be a value indicating how much the steering assist current deviates from the reference value. There may be provided one or more difference values.

Here, the reference range is a measure for determining the state of the steering assist current, and may be a measure including an error range. The reference range may be preset but, without limitations thereto, may be provided in real time. There may be provided one or more reference ranges.

In other words, the comparator 421 may generate a difference value by comparing the steering assist current sensing value with the reference value, and may generate a comparison result by comparing the difference value with a preset reference range.

Here, there may be provided one or more comparison results.

In particular, the comparison result may include a first comparison result and a second comparison result.

In an example, the comparator 421 may compare the difference value with the preset reference range to generate the first comparison result when the difference value is positioned within the preset reference range (or falls within the reference range).

Here, the reference range may include a value between a minimum value and a maximum value, and the minimum value and the maximum value. Accordingly, when it is positioned within the reference range may mean when it is positioned at the value between the minimum value and the maximum value, and the minimum value and the maximum value.

Here, the first comparison result may be a signal indicating that the steering assist current is in a normal state.

In another example, the comparator 421 may compare the difference value with the preset reference range to generate the second comparison result when the difference value is positioned outside the preset reference range (or falls outside the reference range, or does not fall within the reference range).

Here, the reference range may include a value between a minimum value and a maximum value, and the minimum value and the maximum value. When it is positioned outside the reference range may mean that it is not positioned at the value between the minimum value and the maximum value, the minimum value and the maximum value, e.g., that it is positioned at a value other than the value between the minimum value and the maximum value, the minimum value, and the maximum value.

Here, the second comparison result may be a signal indicating that the steering assist current is in an abnormal state.

Meanwhile, the repulsive force path controller 420 according to the present embodiments may further include a reference value provider 424.

The reference value provider 424 may provide a reference value. In other words, the reference value provider 424 may provide the reference value to the comparator 421.

Here, the reference value may include any value that may serve as a reference. In particular, the reference value may include a reference voltage value. For example, the current assist current sensing value input to the comparator 421 may be a value obtained by sensing the steering assist current, and may be a voltage value corresponding to (or proportional to) the steering assist current. Accordingly, the reference value provided by the reference value provider 424 may be a reference voltage value for comparing with the current assist current sensing value input to the comparator 421, e.g., a voltage value corresponding to (or proportional to) the steering assist current.

The reference value provider 424 may provide the reference voltage value based on at least one of a voltage provided from the operation power conversion unit 70, a voltage provided from the controller 50, or a voltage of a voltage source embedded in the corresponding reference value provider 424 but, without limitations thereto, may be any voltage that may provide the reference voltage value.

For example, the reference value provider 424 may set and provide one of the voltage provided from the operation power conversion unit 70, the voltage provided from the controller 50, and the voltage of the voltage source embedded in the corresponding reference value provider as the reference voltage value.

Further, the reference value provider 424 may include a voltage divider. Accordingly, the reference value provider 424 may voltage-divide one of the voltage provided from the operation power conversion unit 70, the voltage provided from the controller 50, and the voltage of the voltage source embedded in the corresponding reference value provider through the voltage divider, and set and provide one of the voltage-divided voltages as the reference voltage value.

The control signal generator 422 may generate a repulsive force path control signal.

For example, the control signal generator 422 may generate a repulsive force path control signal based on the comparison result of the comparator 421 and the operation state of the input-side steering control module 220-1.

Here, there may be provided one or more operation states of the input-side steering control module 220-1. The operation state of the input-side steering control module 220-1 may include a first operation state and a second operation state.

In particular, the first operation state may be a signal indicating that the operation state of the input-side steering control module 220-1 is a normal state. The second operation state may be a signal indicating that the operation state of the input-side steering control module 220-1 is an abnormal state.

Here, the repulsive force path control signal may be a signal for controlling the switching unit 423. There may be provided one or more repulsive force path control signals. The repulsive force path control signal may include a first repulsive force path control signal and a second repulsive force path control signal.

In particular, the first repulsive force path control signal may be a signal indicating to open the repulsive force path unit 410. In other words, the first repulsive force path control signal may be a signal for controlling the switching unit 423 to open that the repulsive force path unit 410. The second repulsive force path control signal may be a signal indicating to connect the repulsive force path unit 410. In other words, the second repulsive force path control signal may be a signal for controlling the switching unit 423 to connect the repulsive force path unit 410.

Accordingly, the control signal generator 422 may generate one of the first repulsive force path control signal and the second repulsive force path control signal based on one of the first comparison result and the second comparison result of the comparator 421 and one of the first operation state and the second operation state of the input-side steering control module 220-1.

In an example, the control signal generator 422 may generate the first repulsive force path control signal based on the first comparison result and the first operation state.

In another example, the control signal generator 422 may generate the first repulsive force path control signal based on the first comparison result and the second operation state.

In another example, the control signal generator 422 may generate the first repulsive force path control signal based on the second comparison result and the first operation state.

In another example, the control signal generator 422 may generate the second repulsive force path control signal based on the second comparison result and the second operation state.

The switching unit 423 may control the repulsive force path unit 410. For example, the switching unit 423 may control the repulsive force path unit 410 based on the repulsive force path control signal.

The switching unit 423 may be positioned on the repulsive force path unit 410.

The switching unit 423 may control the repulsive force path unit 410. For example, the switching unit 423 may control the repulsive force path unit 410 based on the repulsive force path control signal. In other words, the switching unit 423 may open or connect the repulsive force path unit 410 based on the repulsive force path control signal. In other words, the switching unit 423 may control the repulsive force path unit 410 based on the repulsive force path control signal to open or connect the repulsive force path unit 410.

In particular, the switching unit 423 may open or connect the repulsive force path unit 410 based on one of the first repulsive force path control signal and the second repulsive force path control signal.

In an example, the switching unit 423 may open the repulsive force path unit 410 based on the first repulsive force path control signal.

In another example, the switching unit 423 may connect the repulsive force path unit 410 based on the second repulsive force path control signal.

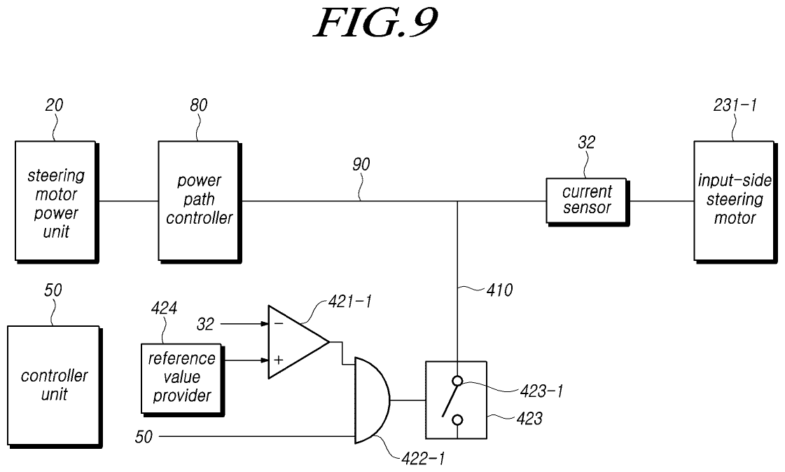

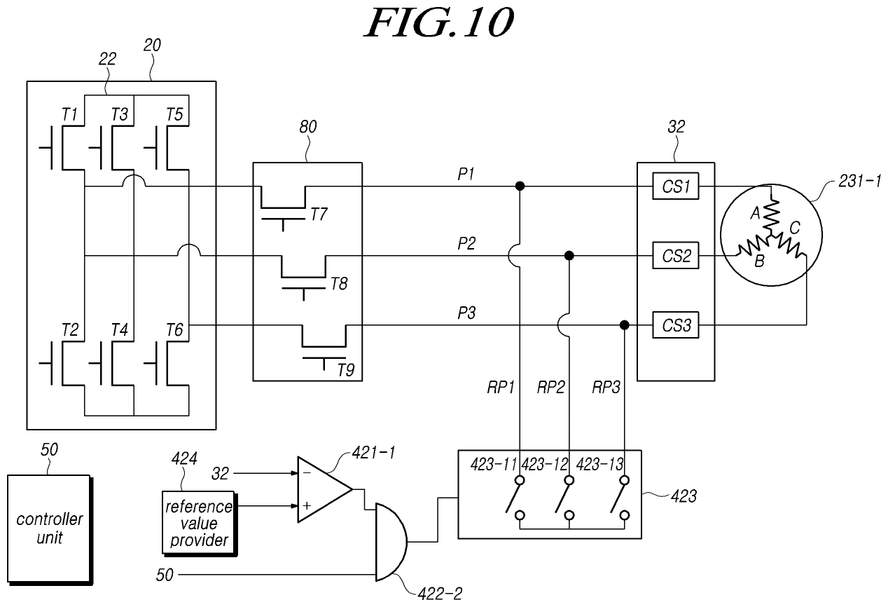

FIGS. 9 and 10 are views specifically illustrating repulsive force control according to the present embodiments.

Referring to FIG. 9, the comparator 421 may include an OP amplifier 421-1.

The OP amplifier 421-1 may operate and amplify a steering assist current sensing value and a reference value to generate a comparison result.

Meanwhile, since the description made above in connection with the comparator 421 may also be applied to the OP amplifier 421-1, a duplicate description is omitted as much as possible for simplicity of description.

The OP amplifier 421-1 may generate a difference value by comparing the steering assist current sensing value input to the negative input terminal with the reference value input to the positive input terminal, generate a comparison result by comparing the difference value with a predetermined reference range, and output the comparison result to the output terminal.

In an example, the OP amplifier 421-1 may compare the difference value with the predetermined reference range, and when the difference value is positioned within the predetermined reference range (or falls within the reference range), the OP amplifier 421-1 may generate the first comparison result and output the first comparison result to the output terminal.

Here, the first comparison result may be a signal indicating that the steering assist current is in a normal state.

In another example, the OP amplifier 421-1 may compare the difference value with the predetermined reference range, and when the difference value is positioned outside the predetermined reference range (or falls outside the reference range, or does not fall within the reference range), the OP amplifier 421-1 may generate the second comparison result and output the second comparison result to the output terminal.

Here, the second comparison result may be a signal indicating that the steering assist current is in an abnormal state.

The control signal generator 422 may include an AND gate 422-1.

The AND gate 422-1 may generate a repulsive force path control signal by performing logical conjunction on the comparison result of the comparator and the operation state of the input-side steering control module 220-1.

Meanwhile, the description made above in the control signal generator 422 may also be applied to the AND gate 422-1, and thus a duplicate description is omitted as much as possible for simplicity of description.

The AND gate 422-1 may generate a repulsive force path control signal by performing logical conjunction on the comparison result of the comparator 421 input to each input terminal and the operation state of the input-side steering control module 220-1, and output the repulsive force path control signal to the output terminal.

For example, the AND gate 422-1 may generate one of the first repulsive force path control signal and the second repulsive force path control signal based on one of the first comparison result and the second comparison result of the comparator 421 input to the input terminal and one of the first operation state and the second operation state of the input-side steering control module 220-1 input to the other input terminal and output the generated one to the output terminal.

In an example, the AND gate 422-1 may generate the first repulsive force path control signal based on the first comparison result and the first operation state and output the first repulsive force path control signal to the output terminal.

In another example, the AND gate 422-1 may generate the first repulsive force path control signal based on the first comparison result and the second operation state and output the first repulsive force path control signal to the output terminal.

In another example, the AND gate 422-1 may generate the first repulsive force path control signal based on the second comparison result and the first operation state and output the first repulsive force path control signal to the output terminal.

In another example, the AND gate 422-1 may generate the second repulsive force path control signal based on the second comparison result and the second operation state and output the generated repulsive force path control signal to the output terminal.

Here, the first operation state may be a signal indicating that the operation state of the input-side steering control module 220-1 is a normal state. The second operation state may be a signal indicating that the operation state of the input-side steering control module 220-1 is an abnormal state. The first repulsive force path control signal may be a signal indicating to open the repulsive force path unit 410. The second repulsive force path control signal may be a signal indicating to connect the repulsive force path unit 410.

The switching unit 423 may include a switching element 423-1.

The switching element 423-1 may be turned on or off based on the repulsive force path control signal to control the repulsive force path unit 410. In other words, the switching element 423-1 may be turned on or off based on the repulsive force path control signal to open or connect the repulsive force path unit 410.

Meanwhile, the description made above in the switching unit 423 may also be applied to the switching element 423-1, and thus a duplicate description is omitted as much as possible for simplicity of description.

In particular, the switching element 423-1 may be turned on or off based on one of the first repulsive force path control signal and the second repulsive force path control signal to open or connect the repulsive force path unit 410.

In an example, the switching element 423-1 may be turned off based on the first repulsive force path control signal to open the repulsive force path unit 410.

In another example, the switching element 423-1 may be turned on based on the second repulsive force path control signal to connect the repulsive force path unit 410.

Here, the switching element 423-1 may include a switching element that is turned on when it is a high signal and turned off when it is a low signal but, without limitations thereto, may include a switching element that is turned on when it is a low signal and turned off when it is a high signal.

Meanwhile, the input-side steering control module 220-1 according to the present embodiments may include at least one of a steering motor power source unit 20, a power path unit 90, a power path controller 80, a current sensor 32, and a controller unit 50.

The steering motor power source unit 20 may generate a steering assist current. The steering motor power source unit 20 may be connected with the input-side steering motor 231-1. The steering motor power source unit 20 may provide a steering assist current to the input-side steering motor 231-1. In other words, the steering motor power source unit 20 may provide the steering assist current to the input-side steering motor 231-1 through the power path unit 90. The steering motor power source unit 20 may include an inverter 22.

The power path unit 90 may be positioned between the steering motor power source unit 20 and the input-side steering motor 231-1. The power path unit 90 may connect the steering motor power source unit 20 and the input-side steering motor 231-1. The steering assist current may flow through the power path unit 90.

The power path controller 80 may be positioned on the power path unit 90. The power path controller 80 may open or connect the power path unit 90. The power path controller 80 may open or connect the power path unit 90 to provide or cut off the steering assist current to the input-side steering motor 231-1.

The current sensor 32 may obtain a steering assist current sensing value by sensing the steering assist current. The current sensor 32 may be positioned on the power path unit 90. For example, the current sensor 32 may be positioned on the power path unit 90 between the repulsive force path unit 410 and the input-side steering motor 231-1, or may be positioned on the power path unit 90 between the repulsive force path unit 410 and the power path controller 80.

However, the current sensor 32 is not limited to the above-described position, and may be positioned in the repulsive force path unit 410 and/or the steering motor power source unit 20 to sense the steering assist current to obtain the steering assist current sensing value. In other words, the current sensor 32 may be positioned anywhere it is possible to obtain the steering assist current sensing value by sensing the steering assist current.

The controller unit 50 may receive the state of the vehicle from the vehicle. The controller unit 50 may determine the state of the vehicle. For example, the controller unit 50 may determine the start state of the vehicle. In other words, the controller unit 50 may determine whether the vehicle is turned on or off.

The controller unit 50 may control the operation of the components included in the input-side steering module. For example, the controller unit 50 may control the operation of at least one of the steering motor power source unit 20 (e.g., the inverter 22), the power path controller 80 (e.g., the PCO), the current sensor 32, the comparator 421 (e.g., the OP amplifier 421-1), the control signal generator 422 (e.g., the AND gate 422-1), the switching unit 423 (e.g., the switching element 423-1), and the reference value provider 424.

In particular, the controller unit 50 may control the operation of at least one of the power path controller 80 and the control signal generator 422 based on at least one of the start state of the vehicle and the operation state of the input-side steering control module 220-1.

In an example, when the vehicle is turned off, the controller unit 50 may control the power path controller 80 to open the power path unit 90, and may control the control signal generator 422 to open the repulsive force path unit 410 by the switching unit 423.

Here, the power path controller 80 may include a PCO, and in particular, the PCO may include a transistor. The switching unit 423 may include a switching element 423-1. The control signal generator 422 may include an AND gate 422-1.

In other words, when the vehicle is turned off, the controller unit 50 may provide an OFF signal to the PCO (e.g., transistor) of the power path controller 80 so that the PCO (e.g., transistor) of the power path controller 80 is turned off to open the power path unit 90, and provide the first operation state to the input terminal of the AND gate 422-1 of the control signal generator 422 so that the switching element 423-1 of the switching unit 423 is turned off by the first repulsive force path control signal output from the output terminal of the AND gate 422-1 of the control signal generator 422 to open the repulsive force path unit 410.

Specifically, when the vehicle is in turned off, an indication that the vehicle is in the OFF state may be provided to the controller unit 50.

The controller unit 50 may receive the indication that the vehicle is in the OFF state to determine that the vehicle is in the OFF state, e.g., when the vehicle turns to the OFF state, provide an OFF signal to the PCO (e.g., transistor) of the power path controller 80. In this case, the PCO (e.g., transistor) of the power path controller 80 may be turned off by the OFF signal, and the power path unit 90 may be opened. Accordingly, the steering assist current provided from the steering motor power source unit 20 may not be provided to the input-side steering motor 231-1 by the opened power path unit 90.

Further, the controller unit 50 may receive the indication that the vehicle is in the OFF state from the vehicle to determine that the vehicle is in the OFF state, e.g., when the vehicle turns to the OFF state, provide the first operation state to the input terminal of the AND gate 422-1 of the control signal generator 422. The AND gate 422-1 of the control signal generator 422 may output the first repulsive force path control signal to the output terminal by the first operation state provided to the input terminal. The switching element 423-1 of the switching unit 423 may be turned off by the first repulsive force path control signal, and the repulsive force path unit 410 may be opened.

In another example, when the vehicle is turned on, the controller unit 50 may control the power path controller 80 to connect the power path unit 90, and may control the control signal generator 422 to open the repulsive force path unit 410 by the switching unit 423.

Here, the power path controller 80 may include a PCO, and in particular, the PCO may include a transistor. The switching unit 423 may include a switching element 423-1. The control signal generator 422 may include an AND gate 422-1.

In other words, when the vehicle is turned on, the controller unit 50 may provide an ON signal to the PCO (e.g., transistor) of the power path controller 80 so that the PCO (e.g., transistor) of the power path controller 80 is turned on to connect the power path unit 90, and provide the first operation state to the input terminal of the AND gate 422-1 of the control signal generator 422 so that the switching element 423-1 of the switching unit 423 is turned off to open the repulsive force path unit 410 by the first repulsive force path control signal output from the output terminal of the AND gate 422-1 of the control signal generator 422.

Specifically, when the vehicle is in turned on, an indication that the vehicle is in the ON state may be provided to the controller unit 50.

The controller unit 50 may receive the indication that the vehicle is in the ON state to determine that the vehicle is in the ON state, e.g., when the vehicle is turned on, provide an ON signal to the PCO (e.g., transistor) of the power path controller 80. In this case, the PCO (e.g., transistor) of the power path controller 80 may be turned on by the ON signal, connecting the power path unit 90. Accordingly, the steering assist current provided from the steering motor power source unit 20 may be provided to the input-side steering motor 231-1 by the connected power path unit 90.

Further, the controller unit 50 may receive the indication that the vehicle is in the ON state from the vehicle to determine that the vehicle is in the ON state, e.g., when the vehicle turns to the ON state, provide the first operation state to the input terminal of the AND gate 422-1 of the control signal generator 422. The AND gate 422-1 of the control signal generator 422 may output the first repulsive force path control signal to the output terminal by the first operation state provided to the input terminal. The switching element 423-1 of the switching unit 423 may be turned off by the first repulsive force path control signal, and the repulsive force path unit 410 may be opened.

The controller unit 50 may control the power path controller 80 based on the start state of the vehicle, the driving state of the vehicle, and the operation state of the input-side steering control module 220-1.

In other words, the controller unit 50 may control the power path controller 80 based on the state in which the vehicle is in the ON state, the vehicle being driven, and the operation state of the input-side steering control module 220-1.

In an example, the controller unit 50 may control the power path controller 80 to connect the power path unit 90 when the vehicle is in the ON state, the vehicle is being driven, and the input-side steering control module 220-1 is in the normal state.

Here, the power path controller 80 may include a PCO, and in particular, the PCO may include a transistor.

In other words, when the vehicle is in the ON state, the vehicle is being driven, and the input-side steering control module 220-1 is in the normal state, the controller unit 50 may provide the ON signal to the PCO (e.g., transistor) of the power path controller 80 to maintain the PCO (e.g., transistor) of the power path controller 80 in the ON state to connect the power path unit 90.

Specifically, the vehicle may provide a signal or information about a state in which the vehicle is in the ON state and the vehicle is being driven to the controller unit 50. The controller unit 50 may determine that the operation state of the input-side steering control module 220-1 is the normal state.

The controller unit 50 may provide the ON signal to the PCO (e.g., transistor) of the power path controller 80 when the vehicle is in the ON state, the vehicle is being driven, and the input-side steering control module 220-1 is in the normal state. In this case, the PCO (e.g., transistor) of the power path controller 80 may be maintained in the ON state by the ON signal, and the power path unit 90 may remain connected. Accordingly, the steering assist current provided from the steering motor power source unit 20 may be provided to the input-side steering motor 231-1 by the connected power path unit 90.

Meanwhile, the controller unit 50 may provide the first operation state when the operation state of the input-side steering control module 220-1 is the normal state. For example, the controller unit 50 may provide the first operation state when the vehicle is in the ON state, the vehicle is being driven, and the operation state of the input-side steering control module 220-1 is the normal state.

The comparator 421 may generate the first comparison result or the second comparison result by comparing the steering assist current sensing value with the reference value. The control signal generator 422 may generate a first repulsive force path control signal based on the first comparison result or the second comparison result of the comparator 421 and the first operation state. The switching unit 423 may open the repulsive force path unit 410 based on the first repulsive force path control signal.

Here, the comparator 421 may include an OP amplifier 421-1, the control signal generator 422 may include an AND gate 422-1, and the switching unit 423 may include a switching element 423-1.

Specifically, the vehicle may provide a signal or information about a state in which the vehicle is in the ON state and the vehicle is being driven to the controller unit 50. The controller unit 50 may determine that the operation state of the input-side steering control module 220-1 is the normal state.

The controller unit 50 may provide the first operation state to the input terminal of the AND gate 422-1 of the control signal generator 422 when the vehicle is in the ON state, the vehicle is being driven, and the operation state of the input-side steering control module 220-1 is the normal state.

The OP amplifier 421-1 of the comparator 421 may compare the steering assist current sensing value provided through the negative input terminal with the reference value provided through the positive input terminal to generate the first comparison result or the second comparison result and output the same to the output terminal. The AND gate 422-1 of the control signal generator 422 may generate the first repulsive force path control signal based on the first comparison result or the second comparison result of the OP amplifier 421-1 of the comparator 421 provided through the input terminal and the first operation state of the controller unit 50 provided through another input terminal, and output the first repulsive force path control signal to the output terminal. The switching element 423-1 of the switching unit 423 may open the repulsive force path unit 410 based on the first repulsive force path control signal.

As described above, when the operation state of the input-side steering control module 220-1 is the normal state, the repulsive force controller 400 according to the present embodiments may control the repulsive force path unit 410 to be opened regardless of the state (normal or abnormal state) of the steering assist current.

In another example, when the vehicle is in the ON state, the vehicle is being driven, and the operation state of the input-side steering control module 220-1 is the abnormal state, the controller unit 50 may control the power path controller 80 to open the power path unit 90.

Here, the power path controller 80 may include a PCO, and in particular, the PCO may include a transistor.

In other words, when the vehicle is in the ON state, the vehicle is being driven, and the input-side steering control module 220-1 is in the abnormal state, the controller unit 50 may provide the OFF signal to the PCO (e.g., transistor) of the power path controller 80 to turn off the PCO (e.g., transistor) of the power path controller 80 to open the power path unit 90.

Specifically, the vehicle may provide a signal or information about a state in which the vehicle is in the ON state and the vehicle is being driven to the controller unit 50. The controller unit 50 may determine that the operation state of the input-side steering control module 220-1 is the abnormal state.

The controller unit 50 may provide the OFF signal to the PCO (e.g., transistor) of the power path controller 80 when the vehicle is in the ON state, the vehicle is being driven, and the input-side steering control module 220-1 is in the abnormal state. In this case, the PCO (e.g., transistor) of the power path controller 80 may be turned off by the OFF signal, and the power path unit 90 may be opened. Accordingly, the steering assist current provided from the steering motor power source unit 20 may not be provided to the input-side steering motor 231-1 by the connected power path unit 90.

Meanwhile, the controller unit 50 may provide the second operation state when the operation state of the input-side steering control module 220-1 is the abnormal state. For example, the controller unit 50 may provide the second operation state when the vehicle is in the ON state, the vehicle is being driven, and the operation state of the input-side steering control module 220-1 is the abnormal state.

The comparator 421 may generate the first comparison result or the second comparison result by comparing the steering assist current sensing value with the reference value. The control signal generator 422 may generate the first repulsive force path control signal or the second repulsive force path control signal based on the first comparison result or the second comparison result of the comparator 421 and the second operation state. The switching unit 423 may open or connect the repulsive force path unit 410 based on the first repulsive force path control signal or the second repulsive force path control signal.

Here, the comparator 421 may include an OP amplifier 421-1, the control signal generator 422 may include an AND gate 422-1, and the switching unit 423 may include a switching element 423-1.

Specifically, the vehicle may provide a signal or information about a state in which the vehicle is in the ON state and the vehicle is being driven to the controller unit 50. The controller unit 50 may determine that the operation state of the input-side steering control module 220-1 is the abnormal state.

The controller unit 50 may provide the second operation state to the input terminal of the AND gate 422-1 of the control signal generator 422 when the vehicle is in the ON state, the vehicle is being driven, and the operation state of the input-side steering control module 220-1 is the abnormal state.

The OP amplifier 421-1 of the comparator 421 may compare the steering assist current sensing value provided through the negative input terminal with the reference value provided through the positive input terminal to generate the first comparison result or the second comparison result and output the same to the output terminal. The AND gate 422-1 of the control signal generator 422 may generate the first repulsive force path control signal or the second repulsive force path control signal based on the first comparison result or the second comparison result of the OP amplifier 421-1 of the comparator 421 provided through the input terminal and the second operation state of the controller unit 50 provided through another input terminal, and output the same to the output terminal. The switching element 423-1 of the switching unit 423 may open or connect the repulsive force path unit 410 based on the first repulsive force path control signal or the second repulsive force path control signal.

In an example, when the comparator 421 generates the first comparison result, the control signal generator 422 may generate the first repulsive force path control signal based on the first comparison result and the second operation state of the comparator 421. The switching unit 423 may open the repulsive force path unit 410 based on the first repulsive force path control signal.

Specifically, when the OP amplifier 421-1 of the comparator 421 generates and outputs the first comparison result to the output terminal, the AND gate 422-1 of the control signal generator 422 may generate the first repulsive force path control signal based on the first comparison result of the OP amplifier 421-1 of the comparator 421 provided through the input terminal and the second operation state of the controller unit 50 provided through another input terminal, and output the first repulsive force path control signal to the output terminal. The switching element 423-1 of the switching unit 423 may open the repulsive force path unit 410 based on the first repulsive force path control signal.

In another example, when the comparator 421 generates the second comparison result, the control signal generator 422 may generate the second repulsive force path control signal based on the second comparison result of the comparator 421 and the second operation state. The switching unit 423 may connect the repulsive force path unit 410 based on the second repulsive force path control signal.

Specifically, when the OP amplifier 421-1 of the comparator 421 generates and outputs the second comparison result to the output terminal, the AND gate 422-1 of the control signal generator 422 may generate the second repulsive force path control signal based on the second comparison result of the OP amplifier 421-1 of the comparator 421 provided through the input terminal and the second operation state of the controller unit 50 provided through another input terminal, and output the second repulsive force path control signal to the output terminal. The switching element 423-1 of the switching unit 423 may connect the repulsive force path unit 410 based on the second repulsive force path control signal.

As described above, the repulsive force controller 400 according to the present embodiments may control the repulsive force path unit 410 to be connected only when the operation state of the input-side steering control module 220-1 is the abnormal state and the steering assist current is in the abnormal state. Accordingly, the repulsive force controller 400 according to the present embodiments may control the repulsive force of the input-side steering motor 231-1.

FIG. 10 is a view illustrating FIG. 9 in detail, and since the description of FIG. 9 may be applied thereto, a duplicate description of FIG. 9 is omitted below for simplicity of description.

The steering motor power source unit 20 may include an inverter 22.

The inverter 22 may include a transistor. There may be provided one or more transistors. For example, the inverter 22 may include first to sixth transistors T1 to T6. The inverter 22 may be a three-phase inverter 22.

The power path controller 80 may include a transistor. There may be provided one or more transistors. For example, the power path controller 80 may include seventh to ninth transistors T7 to T9.

There may be provided one or more current sensors 32. For example, the current sensor 32 is illustrated as including the first to third current sensors CS1 to CS3 for convenience of description but, without limitations thereto, the current sensor 32 may include at least one of the first to third current sensors CS1 to CS3.

Further, the current sensor 32 may be positioned in the power paths P1, P2, and P3 included in the power path unit 90. For example, the current sensor 32 may be positioned in at least one of a power path unit 90 (or a power path) between a portion where the power path unit 90 and the repulsive force path unit 410 are connected and the input-side steering motor 231-1, and a power path unit 90 (or a power path) between the power path controller 80 and a portion where the power path unit 90 and the repulsive force path unit 410 are connected. However, the current sensor 32 is not limited to the above-described position, and may be positioned on the repulsive force path or may be positioned on the inverter 22.

The power path unit 90 may include a power path. There may be provided one or more power paths. For example, the power path unit 90 may include first to third power paths PI to P3.

The repulsive force path unit 410 may include a repulsive force path. There may be provided one or more repulsive force paths. For example, the repulsive force path unit 410 may include a first repulsive force path to a third repulsive force path RP1 to RP3.

The repulsive force path controller 420 may include a switching element 423-1. There may be provided one or more switching elements 423-1. For example, the switching element 423-1 may include a first switching element 423-11 to a third switching element 423-13. The switching element 423-1 may include a switch and/or a transistor.

Hereinafter, a case in which the switching element 423-1 includes a transistor is described.

There may be provided one or more transistors. For example, the repulsive force path controller 420 may include tenth to twelfth transistors T10 to T12. Here, the tenth transistor T10 may correspond to the first switching element 423-11, the eleventh transistor T11 may correspond to the second switching element 423-12, and the twelfth transistor T12 may correspond to the third switching element 423-13.

The comparator 421 may include an OP amplifier 421-1, and the control signal generator 422 may include an AND gate 422-1. There may be provided one or more comparators 421 (e.g., the OP amplifier 421-1) and one or more control signal generators 422 (e.g., the AND gate 422-1).

For example, when one comparator 421 (e.g., the OP amplifier 421-1) and one control signal generator 422 (e.g., the AND gate 422-1) are provided, the control signal generator 422 (e.g., the AND gate 422-1) may control all of the transistors (e.g., the tenth transistor to the twelfth transistor T10 to T12) included in the repulsive force path controller 420.

Further, when as many comparators 421 (e.g., the OP amplifier 421-1) and control signal generators 422 (e.g., the AND gate 422-1) as corresponding to (or match) the number of transistors (e.g., the tenth transistor to the twelfth transistor T10 to T12) included in the repulsive force path controller 420, each control signal generator 422 (e.g., the AND gate 422-1) may control each transistor (e.g., the tenth transistor to the twelfth transistor T10 to T12) included in the repulsive force path controller 420. In other words, when the repulsive force path controller 420 includes three transistors, three comparators 421 (e.g., the OP amplifier 421-1) and three control signal generators 422 (e.g., the AND gate 422-1) may be included, and may be controlled by the three transistors, respectively, included in the repulsive force path controller 420.

The input-side steering motor 231-1 may include one or more phases. For example, the input-side steering motor 231-1 may include Ath to Cth phases. In other words, the input-side steering motor 231-1 may be a three-phase motor.

Specifically, the first transistor T1 and the second transistor T2 of the first inverter 22 may be connected in series with each other. One point between the first transistor T1 and the second transistor T2 connected in series in the inverter 22 and the Ath phase of the input-side steering motor 231-1 may be connected through the first power path P1 of the power path unit 90. The seventh transistor T7 of the power path controller 80 may be positioned on the first power path P1 of the power path unit 90. The first current sensor CS1 may be positioned at any point on the first power path P1 of the power path unit 90 connecting the seventh transistor T7 of the power path controller 80 and the Ath phase of the input-side steering motor 231-1. The first repulsive force path RP1 of the repulsive force path unit 410 may be connected to any point on the first power path P1 of the power path unit 90 connecting the seventh transistor T7 of the power path controller 80 and the Ath phase of the input-side steering motor 231-1. The tenth transistor T10 of the repulsive force path controller 420 may be positioned on the first repulsive force path RP1 of the repulsive force path unit 410.

The third transistor T3 and the fourth transistor T4 of the inverter 22 may be connected in series. One point between the third transistor T3 and the fourth transistor T4 connected in series in the inverter 22 and the Bth phase of the input-side steering motor 231-1 may be connected through the second power path P2 of the power path unit 90. The eighth transistor T8 of the power path controller 80 may be positioned on the second power path P2 of the power path unit 90. The second current sensor CS2 may be positioned at any point on the second power path P2 of the power path unit 90 connecting the eighth transistor T8 of the power path controller 80 and the Bth phase of the input-side steering motor 231-1. The second repulsive force path RP2 of the repulsive force path unit 410 may be connected to any point on the second power path P2 of the power path unit 90 connecting the eighth transistor T8 of the power path controller 80 and the Bth phase of the input-side steering motor 231-1. The eleventh transistor T11 of the repulsive force path controller 420 may be positioned on the second repulsive force path RP2 of the repulsive force path unit 410.

The fifth transistor T5 and the sixth transistor T6 of the inverter 22 may be connected in series. One point between the fifth transistor T5 and the sixth transistor T6 connected in series in the inverter 22 and the Cth phase of the input-side steering motor 231-1 may be connected through the third power path P3 of the power path unit 90. The ninth transistor T9 of the power path controller 80 may be positioned on the third power path P3 of the power path unit 90. The third current sensor CS3 may be positioned at any point on the third power path P3 of the power path unit 90 connecting the ninth transistor T9 of the power path controller 80 and the Cth phase of the input-side steering motor 231-1. The third repulsive force path RP3 of the repulsive force path unit 410 may be connected to any point on the third power path P3 of the power path unit 90 connecting the ninth transistor T9 of the power path controller 80 and the Cth phase of the input-side steering motor 231-1. The twelfth transistor T12 of the repulsive force path controller 420 may be positioned on the third repulsive force path RP3 of the repulsive force path unit 410.

Here, the current sensor 32 may include at least one of the first current sensor to the third current sensor CS1 to CS3.

The controller unit 50 may control operations of the first to sixth transistors T1 to T6 of the inverter 22 (e.g., operate by sending a signal to the gates of the first to sixth transistors T1 to T6).

The controller unit 50 may control operations of the seventh to ninth transistors T7 to T9 (e.g., operate by sending a signal to the gates of the seventh to ninth transistors T7 to T9) of the power path controller 80.

Referring to FIGS. 1 to 10, the steering assist device 200 according to the present embodiments may include at least one of the input-side steering assist device 200-1 and the output-side steering assist device 200-2.

For example, a steering assist device 200 according to the present embodiments may include an input-side steering actuator 230-1 assisting an input-side mechanism 110 mechanically separated from an output-side mechanism 120 connected with a wheel 150 and connected with a steering wheel 140, and an input-side steering assist device 200-1 including an input-side steering control module 220-1 controlling an input-side steering motor 231-1 included in the input-side steering actuator 230-1. The input-side steering control module 220-1 may include a repulsive force controller 400 controlling a repulsive force of the input-side steering motor 231-1 based on a steering assist current related to the input-side steering motor 231-1 and an operation state of the input-side steering control module 220-1.

The steering assist device 200 according to the present embodiments may further include an output-side steering actuator 230-2 assisting an output-side mechanism 120 mechanically separated from the input-side mechanism 110 connected with the steering wheel 140 and connected with the wheel 150 and an output-side steering control module 220-2 controlling an output-side steering motor 231-2 included in the output-side steering actuator 230-2.

Referring to FIGS. 1 to 10, a steering system 1 according to the present embodiments may include at least one of an input-side mechanism 110, an output-side mechanism 120, an input-side steering assist device 200-1, and an output-side steering assist device 200-2.

For example, a steering system 1 according to the present embodiments may include an input-side mechanism 110 mechanically separated from an output-side mechanism 120 connected with a wheel 150 and connected with a steering wheel 140 and an input-side steering assist device 200-1 including an input-side steering actuator 230-1 assisting the input-side mechanism 110 and an input-side steering control module 220-1 controlling an input-side steering motor 231-1 included in the input-side steering actuator 230-1. The input-side steering control module 220-1 may include a repulsive force controller 400 controlling a repulsive force of the input-side steering motor 231-1 based on a steering assist current related to the input-side steering motor 231-1 and an operation state of the input-side steering control module 220-1.

The steering system 1 according to the present embodiments may further include an output-side mechanism 120 mechanically separated from the input-side mechanism 110 connected with the steering wheel 140 and connected with the wheel 150, and an output-side steering assist device 200-2 including an output-side steering actuator 230-2 assisting the output-side mechanism 120, and an output-side steering control module 220-2 controlling an output-side steering motor 231-2 included in the output-side steering actuator 230-2.

As described above, the repulsive force control device (or repulsive force controller 400) according to the present embodiments is a device that generates torque using motor counter electromotive force when an abnormality occurs in steer-by-wire and may be a circuit that may provide a repulsive force to the steering feel actuator (SFA), e.g., the input-side steering assist device 200-1 or receive counter torque when the driver steers (rotating the input-side steering motor 231-1) even when an abnormality occurs in the SFA, e.g., the input-side steering assist device 200-1.

Thus, the repulsive force control device (or repulsive force controller 400), the steering control device, the steering assist device, and the steering system according to the present embodiments may implement a repulsive force and torque using the counter electromotive voltage of the input-side steering motor 231-1 when the steering feel actuator (SFA) (e.g., the input-side steering assist device) is not controlled due to a system fail in the steer-by-wire system, e.g., control the repulsive force of the input-side steering motor 231-1 based on the operation state of the input-side steering control module 220-1 and the steering assist current, thereby providing repulsive force and torque to the SFA even when the SFA is abnormal, and hence providing stability to the driver.

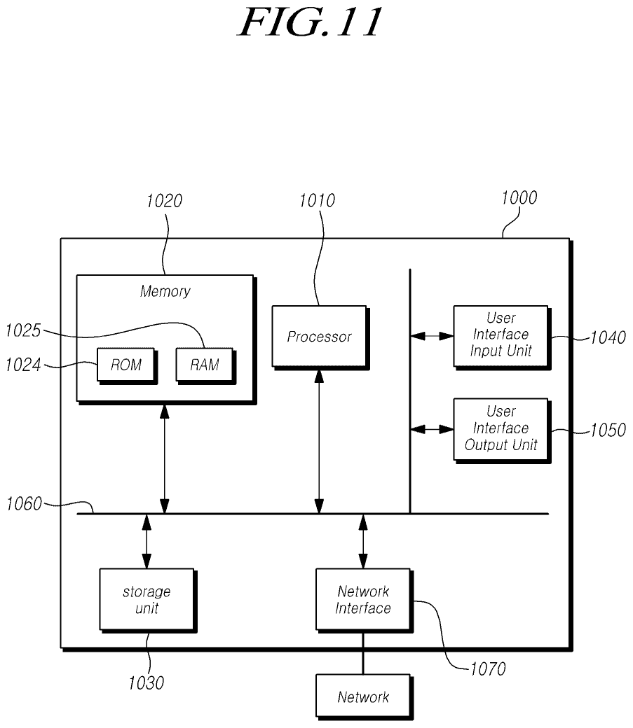

FIG. 11 is a view illustrating a computer system for a steering control device, a steering assist device, and a steering system according to the present embodiments.

Referring to FIG. 11, the above-described embodiments may be implemented as, e.g., a computer-readable recording medium, in a computer system. As illustrated in the drawings, the computer system 1000 of the steering control device, steering assist device, and steering system may include at least one of one or more processors 1010, a memory 1020, a storage unit 1030, a user interface input unit 1040, and a user interface output unit 1050 which may communicate with each other via a bus 1060. Further, the computer system 1000 of the steering control device, steering assist device, and steering system may also include a network interface 1070 for connecting to a network. The processor 1010 may be a central processing unit (CPU) or semiconductor device that executes processing instructions stored in the memory 1020 and/or the storage unit 1030. The memory 1020 and the storage unit 1030 may include various types of volatile/non-volatile storage media. For example, the memory 1200 may include a read only memory (ROM) 1024 and a random access memory (RAM) 1025.

Accordingly, the embodiments may be implemented as a non-volatile computer recording medium storing computer-implemented methods or computer executable instructions. The instructions may be executed by the processor to perform a method according to an embodiment of the disclosure.

The above description has been presented to enable any person skilled in the art to make and use the technical idea of the disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the disclosure. The above description and the accompanying drawings provide an example of the technical idea of the disclosure for illustrative purposes only. That is, the disclosed embodiments are intended to illustrate the scope of the technical idea of the disclosure. Thus, the scope of the disclosure is not limited to the embodiments shown, but is to be accorded the widest scope consistent with the claims. All technical ideas within the scope of the above description should be construed as being included within the scope of the disclosure.

1. A steering control device, comprising:
an input-side steering control module controlling an input-side steering motor to assist an input-side mechanism mechanically separated from an output-side mechanism connected with a wheel and connected with a steering wheel,
wherein the input-side steering control module includes a repulsive force controller controlling a repulsive force of the input-side steering motor based on a steering assist current related to the input-side steering motor and an operation state of the input-side steering control module.

2. The steering control device of claim 1, wherein the repulsive force controller includes:
a repulsive force path unit connected to a power path unit through which the steering assist current flows; and
a repulsive force path controller controlling the repulsive force of the input-side steering motor by controlling the repulsive force path unit based on the steering assist current and the operation state of the input-side steering control module.

3. The steering control device of claim 2, wherein the repulsive force path controller includes:
a comparator circuit generating a comparison result by comparing a steering assist current sensing value obtained by sensing the steering assist current with a reference value;
a control signal generator circuit generating a repulsive force path control signal based on a comparison result of the comparator circuit and the operation state of the input-side steering control module; and
a switching unit controlling the repulsive force path unit based on the repulsive force path control signal.

4. The steering control device of claim 3, wherein the comparator circuit generates the comparison result by generating a difference value by comparing the steering assist current sensing value with the reference value and comparing the difference value with a preset reference range.

5. The steering control device of claim 3, wherein the comparator circuit includes an operational amplifier generating the comparison result by operating and amplifying the steering assist current sensing value and the reference value.

6. The steering control device of claim 3, wherein the control signal generator circuit generates one of a first repulsive force path control signal and a second repulsive force path control signal based on one of a first comparison result and a second comparison result of the comparator circuit and one of a first operation state and a second operation state of the input-side steering control module.

7. The steering control device of claim 3, wherein the control signal generator circuit includes an AND gate generating the repulsive force path control signal by performing logical conjunction on the comparison result of the comparator circuit and the operation state of the input-side steering control module.

8. The steering control device of claim 3, wherein the switching unit opens or connects the repulsive force path unit based on one of a first repulsive force path control signal and a second repulsive force path control signal of the control signal generator circuit.

9. The steering control device of claim 3, wherein the switching unit includes a switching element turned on or off based on the repulsive force path control signal to control the repulsive force path unit.

10. The steering control device of claim 3, wherein the input-side steering control module includes at least one of:
a steering motor power source unit generating the steering assist current;
a power path unit through which the steering assist current flows;
a power path controller opening or connecting the power path unit;
a current sensor obtaining the steering assist current sensing value by sensing the steering assist current; and
a controller unit determining the operation state of the input-side steering control module.

11. The steering control device of claim 10, wherein the controller unit controls an operation of at least one of the power path controller and the control signal generator circuit based on at least one of a start state of a vehicle and the operation state of the input-side steering control module.

12. The steering control device of claim 11, wherein the controller unit controls the power path controller to open the power path unit and controls the control signal generator circuit to open the repulsive force path unit by the switching unit when the vehicle is turned off.

13. The steering control device of claim 11, wherein the controller unit controls the power path controller to connect the power path unit and controls the control signal generator circuit to open the repulsive force path unit by the switching unit when the vehicle is turned on.

14. The steering control device of claim 10, wherein the controller unit controls the power path controller based on a start state of a vehicle, a driving state of the vehicle, and the operation state of the input-side steering control module.

15. The steering control device of claim 14, wherein the controller unit controls the power path controller to connect the power path unit when the vehicle is in an ON state, the vehicle is being driven, and the operation state of the input-side steering control module is a normal state.

16. The steering control device of claim 15, wherein the controller unit provides a first operation state when the vehicle is in the ON state, the vehicle is being driven, and the operation state of the input-side steering control module is a normal state,
wherein the comparator circuit generates a first comparison result or a second comparison result by comparing the steering assist current sensing value with a reference value,
wherein the control signal generator circuit generates a first repulsive force path control signal based on the first comparison result or the second comparison result of the comparator circuit and the first operation state, and
wherein the switching unit opens the repulsive force path unit based on the first repulsive force path control signal.

17. The steering control device of claim 14, wherein the controller unit controls the power path controller to open the power path unit when the vehicle is in the ON state, the vehicle is being driven, and the operation state of the input-side steering control module is an abnormal state.

18. The steering control device of claim 17, wherein the controller unit provides a second operation state when the vehicle is in the ON state, the vehicle is being driven, and the operation state of the input-side steering control module is the abnormal state,
wherein the comparator circuit generates a first comparison result or a second comparison result by comparing the steering assist current sensing value with a reference value,
wherein the control signal generator circuit generates a first repulsive force path control signal or a second repulsive force path control signal based on the first comparison result or the second comparison result of the comparator circuit and the second operation state, and
wherein the switching unit opens or connects the repulsive force path unit based on the first repulsive force path control signal or the second repulsive force path control signal.

19. A steering assist device, comprising:
an input-side steering actuator assisting an input-side mechanism mechanically separated from an output-side mechanism connected with a wheel and connected with a steering wheel; and
an input-side steering assist device including an input-side steering control module controlling an input-side steering motor included in the input-side steering actuator,
wherein the input-side steering control module includes a repulsive force controller controlling a repulsive force of the input-side steering motor based on a steering assist current related to the input-side steering motor and an operation state of the input-side steering control module.

20. A steering system, comprising:
an input-side mechanism mechanically separated from an output-side mechanism connected with a wheel and connected with a steering wheel; and
an input-side steering assist device including an input-side steering actuator assisting the input-side mechanism and an input-side steering control module controlling an input-side steering motor included in the input-side steering actuator,
wherein the input-side steering control module includes a repulsive force controller controlling a repulsive force of the input-side steering motor based on a steering assist current related to the input-side steering motor and an operation state of the input-side steering control module.
